(19) United States
(12) Patent Application Publication
(10) Pub. No.: US 2015/0138658 A1
(43) Pub. Date: May 21, 2015

(54) DOOR MIRROR

(71) Applicant: MURAKAMI CORPORATION, Shizuoka (JP)

(72) Inventors: Eiichi Nishimura, Shizuoka (JP); Toru Shimura, Shizuoka (JP)

(73) Assignee: MURAKAMI CORPORATION, Shizuoka (JP)

(21) Appl. No.: 14/410,871

(22) PCT Filed: Jun. 14, 2013
(86) PCT No.: PCT/JP2013/066481

§ 371 Date: Dec. 23, 2014

(30) Foreign Application Priority Data
Jun. 29, 2012 (JP) 2012-147639

(51) Int. Cl. B60R 1/06; B60R 1/07

(52) U.S. Cl. CPC B60R 1/06; B60R 1/07
USPC 359/871

(57) ABSTRACT

An aspect of the present invention is a door mirror having a door mirror main body attached to a door mirror attaching part of a vehicle body, the door mirror including a shared base fixed to the door mirror attaching part and configured to support the door mirror main body, which is shared, and an exclusive cover configured to cover a peripheral region of the door mirror attaching part and selected from a group of different types of exclusive covers.

### TECHNICAL FIELD

The present invention relates to a door mirror having a door mirror main body attached to a vehicle body.

### BACKGROUND ART

In the related art, a technology of such a field is disclosed in Japanese Published Unexamined Patent Application No. 2007-331601. In the disclosure, there is a mirror base installed between a door mirror attaching part formed at a vehicle body and a mirror assembly (a door mirror main body). The mirror base includes a base main body configured to support the mirror assembly, and a gasket installed at a back surface of the base main body. The base main body has a plate-shaped cover part, a support portion on which the door mirror main body is placed, and a fixing portion fixed to the door mirror attaching part of the vehicle body. The cover part, the support portion and the fixing portion of the base main body are integrally formed with each other.

The fixing portion of the base main body protrudes toward the vehicle body, and is pushed against the door mirror attaching part via a gasket. Then, screws are threaded into a plurality of bosses formed at the fixing portion from the door mirror attaching part side, thus fixing the mirror base to the door mirror attaching part. In addition, a lower end of a door mirror opening and closing unit housed in the mirror assembly (the door mirror main body) is fixed to the base main body by a screw.

### CITATION LIST

### Patent Literature

[Patent Literature 1] Japanese Published Unexamined Patent Application, No. 2007-331601

### SUMMARY OF INVENTION

### Technical Problem

However, in the above-mentioned door mirror of the related art, even when the door mirror main body is meant to be shared between different types of vehicles, an attaching structure, an attaching angle, or the like, of the door mirror attaching part installed at the vehicle body is varied. As a result, the base main body (the base) should be exclusively designed for every type of vehicle, and thus, a general shape or a structure of the base main body should be reconsidered.

The present invention is directed to provide a door mirror capable of sharing a base to which a door mirror main body is attached.

### Solution to Problem

An aspect of the present invention is a door mirror having a door mirror main body attached to a door mirror attaching part of a vehicle body, the door mirror including: a shared base fixed to the door mirror attaching part and configured to support the door mirror main body, which is shared; and an exclusive cover configured to cover a peripheral region of the door mirror attaching part and selected from a group of different types of exclusive covers.

In the door mirror, the shared door mirror main body and the shared base (hereinafter referred to as a “shared base”) are employed in different types of vehicles without modifying the door mirror main body and the base for every type of vehicle. Since the door mirror main body is constituted by assembling various parts and accounts for most of a manufacturing cost of the door mirror, large cost reduction becomes possible when the door mirror main body is shared. However, while sharing of the door mirror main body is generally performed, in order to further reduce the cost, in the present invention, sharing of the base to which the door mirror main body is attached is attempted.

That is, in the door mirror of the aspect of the present invention, the shared base is fixed to the door mirror attaching part of the vehicle body, and the shared base supports the shared door mirror main body. In this way, since the shared base is used, sharing of the base with respect to a plurality of types of vehicles becomes possible. Further, the exclusive cover is selected from the group of different types of exclusive covers, and the exclusive cover covers a peripheral region of the door mirror attaching part. Accordingly, by selecting the exclusive cover depending on the type of vehicle, while attempting to share the base, different designs for every type of vehicle can be realized.

In addition, in the door mirror, the shared base is covered by the exclusive cover. In this case, by covering the shared base with the exclusive cover, different designs for every type of vehicle can be more easily realized.

In addition, in the door mirror, the shared base is exposed. In this case, since the exclusive cover does not cover the shared base, a range covered by the exclusive cover is reduced to that extent. Accordingly, a material cost for manufacture of the exclusive cover is reduced while increasing a degree of freedom in design of the exclusive cover.

### Advantageous Effects of Invention

According to an aspect of the present invention, sharing of the base becomes possible and thus, by also selecting the exclusive cover depending on a type of vehicle, different designs corresponding to the types of vehicles can be realized.

### BRIEF DESCRIPTION OF DRAWINGS

FIGS. 1(a) to 1(c) are perspective views showing a state in which a door mirror according to the present invention is attached to a vehicle body;

FIG. 2 is an exploded perspective view showing a first embodiment of the door mirror according to the present invention;

FIG. 3 is a longitudinal cross-sectional view showing a state in which the door mirror of FIG. 2 is attached;

FIG. 4 is a longitudinal cross-sectional view when another type of exclusive cover is attached;

FIG. 5 is a longitudinal cross-sectional view when still another type of exclusive cover is attached;

FIG. 6 is a longitudinal cross-sectional view when the door mirror is attached to a different type of vehicle from FIG. 3;

FIG. 7 is an exploded perspective view showing a second embodiment of the door mirror according to the present invention;

FIG. 8 is a longitudinal cross-sectional view showing a state in which the door mirror of FIG. 7 is attached;

FIG. 9 is an exploded perspective view showing a third embodiment of the door mirror according to the present invention;

FIG. 10 is an exploded perspective view showing a fourth embodiment of the door mirror according to the present invention;

FIG. 11 is an exploded perspective view showing a fifth embodiment of the door mirror according to the present invention;

FIG. 12 is an exploded perspective view showing a sixth embodiment of the door mirror according to the present invention;

FIG. 13 is a longitudinal cross-sectional view showing a second aspect of a method of fixing a shared base;

FIG. 14 is a longitudinal cross-sectional view showing a third aspect of the method of fixing the shared base; and

FIG. 15 is a longitudinal cross-sectional view showing a fourth aspect of the method of fixing the shared base.

### DESCRIPTION OF EMBODIMENTS

Hereinafter, embodiments of the present invention will be described with reference to the accompanying drawings. Further, the same components throughout description of the drawings are designated by the same reference numerals, and detailed description thereof will be omitted.

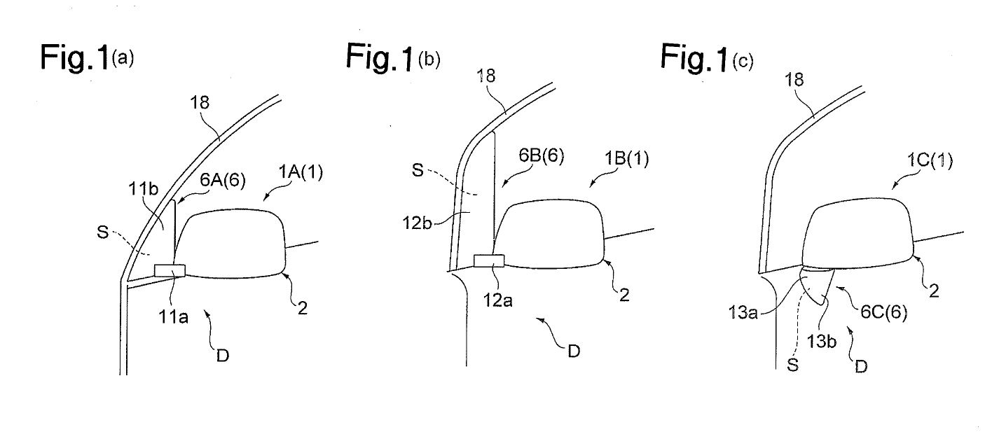

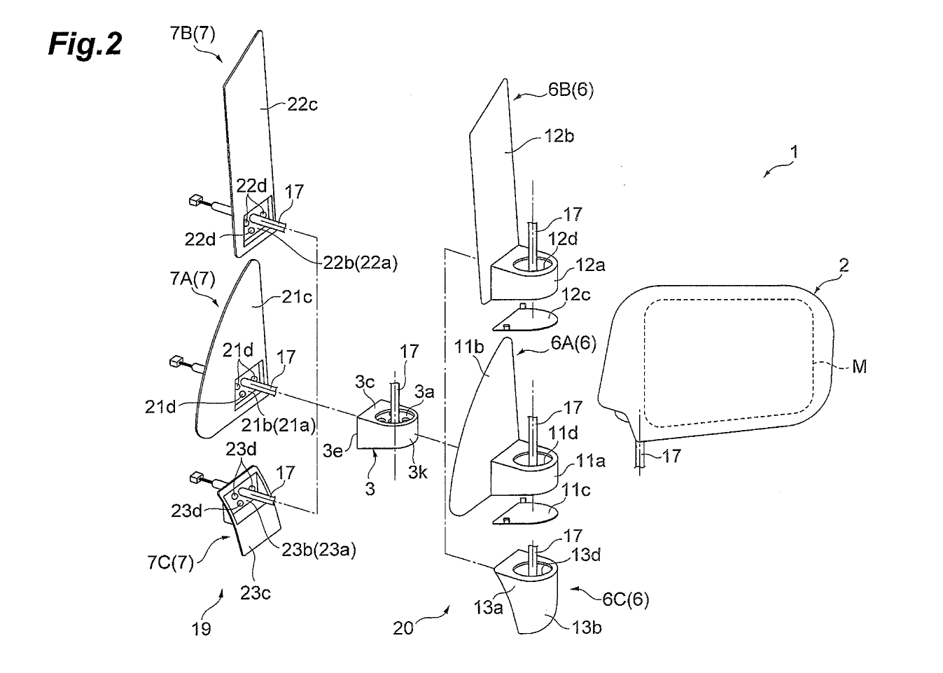

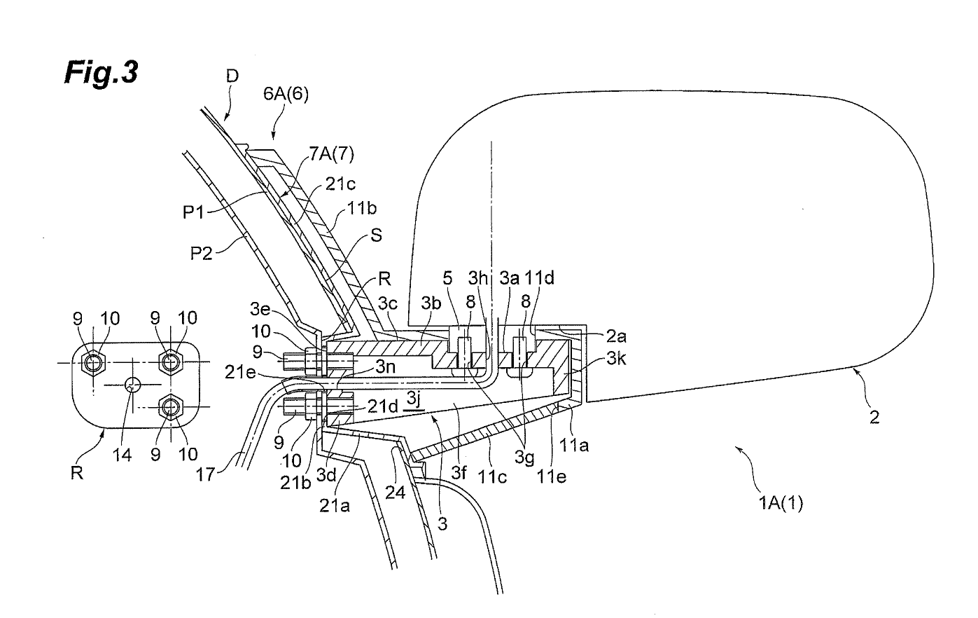

As shown in FIGS. 1 and 2, a door mirror 1 has a motor-driven door mirror main body 2 on which a mirror M is provided, and a shared base 3 serving as a door mirror base configured to attach the door mirror main body 2 to a door D. A door mirror opening and closing unit 5 (see FIG. 3) configured to be able to open and close the door mirror main body 2, a mirror angle adjusting unit configured to adjust a tilting angle of a mirror surface, and so on, are installed in the door mirror main body 2.

The door mirror main body 2 having the same shape and the same structure is shared in different types of vehicles. Further, the shared base 3 having the same shape and the same structure is shared in different types of vehicles. By sharing the door mirror main body 2 and the shared base 3, cost reduction and production of narrow variety of molding equipment become possible due to the sharing.

As shown in FIG. 3, a door mirror attaching part R having a rectangular shape is formed at an inner panel P2 of the door D of the vehicle body. The door mirror 1 is fixed to the door mirror attaching part R. The door mirror main body 2 is attached to the door mirror attaching part R via the shared base 3. The door mirror attaching part R extends in a planar shape and forms a predetermined angle with respect to a horizontal surface. The angle of the door mirror attaching part R with respect to the horizontal surface is common (equal) in a plurality of types of vehicles to which the door mirror 1 is attached. In the example shown in FIG. 3, the door mirror attaching part R extends in a direction substantially perpendicular to the horizontal surface (a vertical direction). The door mirror attaching part R does not necessarily extend in the vertical direction but may extend to form another angle with respect to the horizontal surface. The door mirror attaching part R is not necessarily formed at the inner panel P2 but may be formed at another portion.

The door mirror 1 includes an exclusive cover 6 configured to cover the door mirror attaching part R and a peripheral region S thereof, an exclusive gasket 7 sandwiched between the exclusive cover 6 and the door mirror attaching part R, a plurality of stud bolts 9 installed to protrude from the shared base 3 toward the door mirror attaching part R, and nuts 10 threadedly engaged with the stud bolts 9 and configured to fix the shared base 3 to the door mirror attaching part R. The nut 10 is attached from a back surface side (the inside of the door D) of the door mirror attaching part R.

As shown in FIGS. 1 and 2, the door mirror 1 is configured to form different designs depending on a plurality of types of vehicles. That is, in the door mirror 1, while the door mirror main body 2 and the shared base 3 are used in sharing, as a cover member for exhibiting a design property of the vehicle body, the exclusive cover 6 to which an exclusive design is applied to different types of vehicles is used.

In FIGS. 1 and 2, three types of door mirrors 1 are exemplified. A first type door mirror 1A (see FIG. 1(a)) includes an exclusive cover 6A having a triangular shape formed along a front pillar 18. A second type door mirror 1B (see FIG. 1(b)) includes an exclusive cover 6B having a rectangular shape formed along the front pillar 18. A third type door mirror 1C (see FIG. 1(c)) includes an exclusive cover 6C formed in a three-dimensional shape only at a lower side of the door mirror main body 2.

As shown in FIG. 2, the door mirror 1A has an exclusive gasket 7A having a shape (a triangular shape) corresponding to a door cover part 11b of the exclusive cover 6A having the triangular shape. The door mirror 1B includes an exclusive gasket 7B having a shape (a rectangular shape) corresponding to a door cover part 12b of the exclusive cover 6B having the rectangular shape. The door mirror 1C includes an exclusive gasket 7C having a shape (a rectangular shape) corresponding to the exclusive cover 6C. The exclusive gasket 7A, the exclusive gasket 7B and the exclusive gasket 7C constitute a group of different types of exclusive gaskets 19.

In this way, in the door mirror 1A, the door mirror 1B and the door mirror 1C, by using the exclusive cover 6 (the exclusive cover 6A, the exclusive cover 6B, or the exclusive cover 6C) prepared for different types of vehicles in the same shared base 3, change of the cover becomes possible. The exclusive cover 6A, the exclusive cover 6B and the exclusive cover 6C constitute a group of different types of exclusive covers 20. That is, the door mirror 1A, the door mirror 1B and the door mirror 1C include the exclusive cover 6A, the exclusive cover 6B, and the exclusive cover 6C, respectively, which are the exclusive cover 6 selected from the exclusive cover group 20. In addition, the door mirror 1A, the door mirror 1B and the door mirror 1C include the exclusive gasket 7A, the exclusive gasket 7B, and the exclusive gasket 7C, respectively, which are the exclusive gasket 7 selected from the exclusive gasket group 19.

There may be two kinds of the exclusive cover 6 that constitutes the exclusive cover group 20 or there may be four or more kinds. The exclusive cover 6 that constitutes the exclusive cover group 20 may be designed depending on the number of types of vehicles to which the door mirror 1 is applied.

Specific configurations of the shared base 3, the exclusive cover 6 and the exclusive gasket 7 will be described with reference to FIGS. 2 and 3 while exemplifying the door mirror 1A.

The shared base 3 is formed of a resin or a die-casting material. The shared base 3 is injection molded or die-casting molded using a mold, for example. The shared base 3 has a pedestal part 3a configured to position and fix a lower end of the door mirror opening and closing unit 5 of the door mirror main body 2. The shared base 3 has a horizontal plate part 3b opposite to a lower surface 2a of the door mirror main body 2, an attaching part 3d connected to the vehicle body side (the door mirror attaching part R side) of the horizontal plate part 3b and extending downward, and a peripheral wall 3k connected to a U-shaped periphery of the attaching part 3d and the horizontal plate part 3b and extending downward.

A flat surface 3c is formed at the door mirror main body 2 side (the lower surface 2a side) of the horizontal plate part 3b. The pedestal part 3a is formed at a position slightly recessed from the flat surface 3c. The pedestal part 3a may be formed in a convex shape protruding from the flat surface 3c. The stud bolt 9 protruding toward the door mirror attaching part R is fixed to the attaching part 3d. One harness insertion hole 3n is formed in the attaching part 3d. A wire harness 17 configured to supply power to each unit, a lamp, or the like, in the door mirror main body 2 is inserted into the harness insertion hole 3n. Further, the harness insertion hole 3n is not necessarily formed in the attaching part 3d. A U-shaped notch may be formed in the attaching part 3d. The U-shaped notch enables the wire harness 17 to be easily inserted therethrough, since there is no need to precisely insert the wire harness 17 through a hole.

An attaching surface 3e pressed against the door mirror attaching part R is formed at the door mirror attaching part R side of the attaching part 3d. The attaching surface 3e extends perpendicular to the flat surface 3c. As described above, since the door mirror attaching part R extends in the vertical direction, the attaching surface 3e pressed against the door mirror attaching part R is disposed in the vertical direction. Accordingly, the flat surface 3c perpendicular to the attaching surface 3e is disposed in the horizontal direction. When the door mirror attaching part R forms an angle other than 90 degrees with respect to the horizontal surface, an angle of the attaching surface 3e with respect to the flat surface 3c is also varied. That is, the angle of the attaching surface 3e with respect to the flat surface 3c is equal to the angle of the door mirror attaching part R with respect to the horizontal surface. Accordingly, the flat surface 3c of the shared base 3 fixed to the door mirror attaching part R is constantly disposed in the horizontal direction.

A plurality of screw insertion holes 3g and one harness insertion hole 3h are formed in the pedestal part 3a of the shared base 3. A screw 8 configured to fix the door mirror opening and closing unit 5 of the door mirror main body 2 is inserted through the screw insertion hole 3g. The wire harness 17 is inserted through the harness insertion hole 3h. In addition, an opening 3f is formed in a bottom surface of the shared base 3. An internal space 3j surrounded by the horizontal plate part 3b, the attaching part 3d and the peripheral wall 3k is formed in the shared base 3.

The exclusive cover 6A is formed of a resin and injection-molded using a mold, for example. The exclusive cover 6A has a base cover part 11a configured to cover the shared base 3, and the door cover part 11b connected to the vehicle body side (the door mirror attaching part R side) of the base cover part 11a and having a triangular shape to cover the door D. The base cover part 11a has an inner periphery along an outer periphery of the shared base 3. An opening 11d facing the lower surface 2a of the door mirror main body 2 is formed at the upper surface side of the base cover part 11a. The pedestal part 3a of the shared base 3 is exposed from the opening 11d. A lower end of the door mirror opening and closing unit 5 is inserted into the opening 11d. That is, the base cover part 11a of the exclusive cover 6A covers the shared base 3 in a state in which the pedestal part 3a is exposed. An opening 11e is formed at the bottom surface side of the base cover part 11a. A lower cover 11c configured to cover the opening 11e is installed at the exclusive cover 6A.

The door cover part 11b of the exclusive cover 6A extends along an outer panel P1 of the vehicle body, and covers the peripheral region S of the door mirror attaching part R in the door D. The peripheral region S according to the embodiment is a triangular region (see also FIG. 1) formed at the outer panel P1. A position, a shape and a size of the peripheral region S is not limited to the example. The peripheral region S may be formed at any position, and in any shape and size as long as the region is around the door mirror attaching part R.

The exclusive gasket 7A has a rectangular base seal part 21b sandwiched between the attaching part 3d (the attaching surface 3e) of the shared base 3 and the door mirror attaching part R, and a triangular cover seal part 21c sandwiched between a periphery of the exclusive cover 6A and the outer panel P1. A base fitting part 21a protruding toward the door mirror attaching part R and into which the attaching part 3d of the shared base 3 is fitted is formed at the exclusive gasket 7A. The base seal part 21b is formed at a distal end of the base fitting part 21a (an end part of the door mirror attaching part R). A plurality of bolt insertion holes 21d through which the stud bolts 9 of the shared base 3 are inserted, and one harness insertion hole 21e through which the wire harness 17 is inserted are formed in the base seal part 21b.

Upon assembly of the shared base 3, the exclusive cover 6A and the exclusive gasket 7A to the door D, in a state in which the base fitting part 21a of the exclusive gasket 7A is fitted into an opening 24 of the outer panel P1, the attaching part 3d of the shared base 3 is fitted into the base fitting part 21a. Further, the shared base 3 is pressed against the door mirror attaching part R to be fixed thereto while performing handling of the wire harness 17 from the door mirror main body 2. Then, attachment of the door mirror main body 2 and attachment of the exclusive cover 6A are performed.

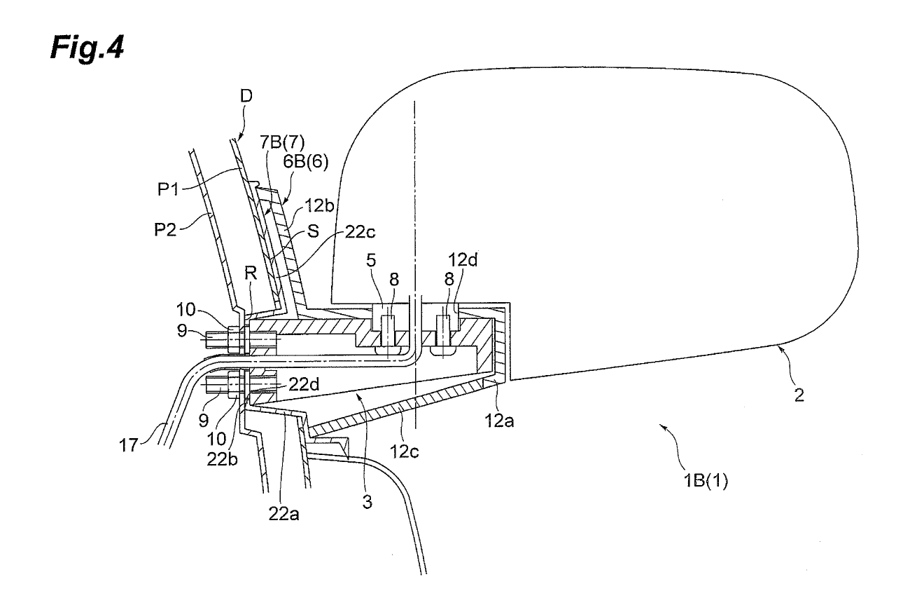

Each of the door mirror 1B and the door mirror 1C has the same configuration as the door mirror 1A. As shown in FIGS. 2 and 4, the exclusive cover 6B of the door mirror 1B has a base cover part 12a configured to cover the shared base 3, the door cover part 12b having a rectangular shape and configured to cover the peripheral region S (see FIG. 1) of the door mirror attaching part R, a lower cover 12c configured to cover an opening of the bottom surface side of the base cover part 12a, and so on. An opening 12d into which the lower end of the door mirror opening and closing unit 5 is inserted is formed at the base cover part 12a. The exclusive gasket 7B of the door mirror 1B has a base fitting part 22a, a base seal part 22b, a cover seal part 22c, a bolt insertion hole 22d, and so on.

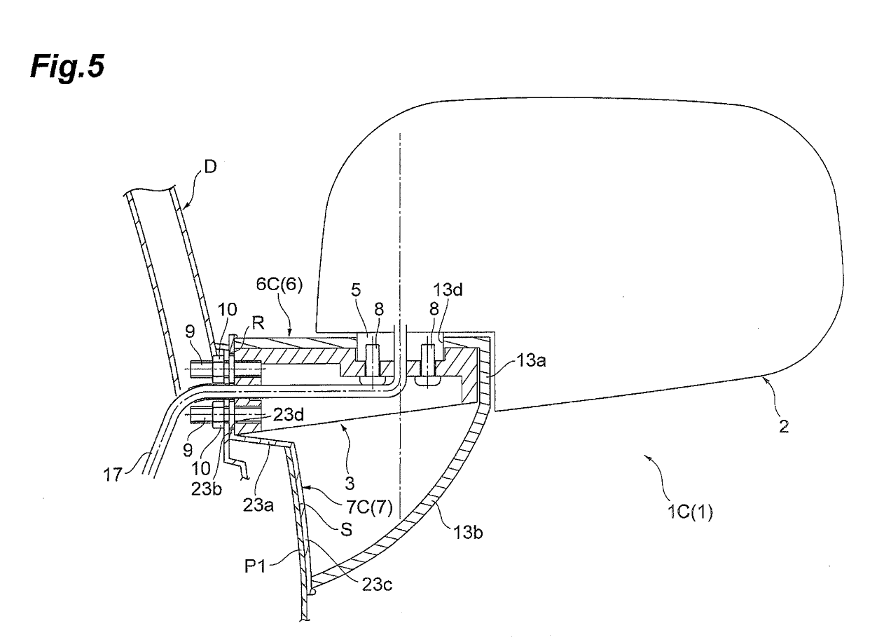

As shown in FIGS. 2 and 5, the exclusive cover 6C of the door mirror 1C has a base cover part 13a configured to cover the shared base 3, a door cover part 13b configured to cover the peripheral region S (see FIG. 1) of the door mirror attaching part R, and so on. No lower cover is installed at the exclusive cover 6C. An opening 13d through which the lower end of the door mirror opening and closing unit 5 is inserted is formed at the base cover part 13a. The exclusive gasket 7C of the door mirror 1C has a base fitting part 23a, a base seal part 23b, a cover seal part 23c, a bolt insertion hole 23d, and so on.

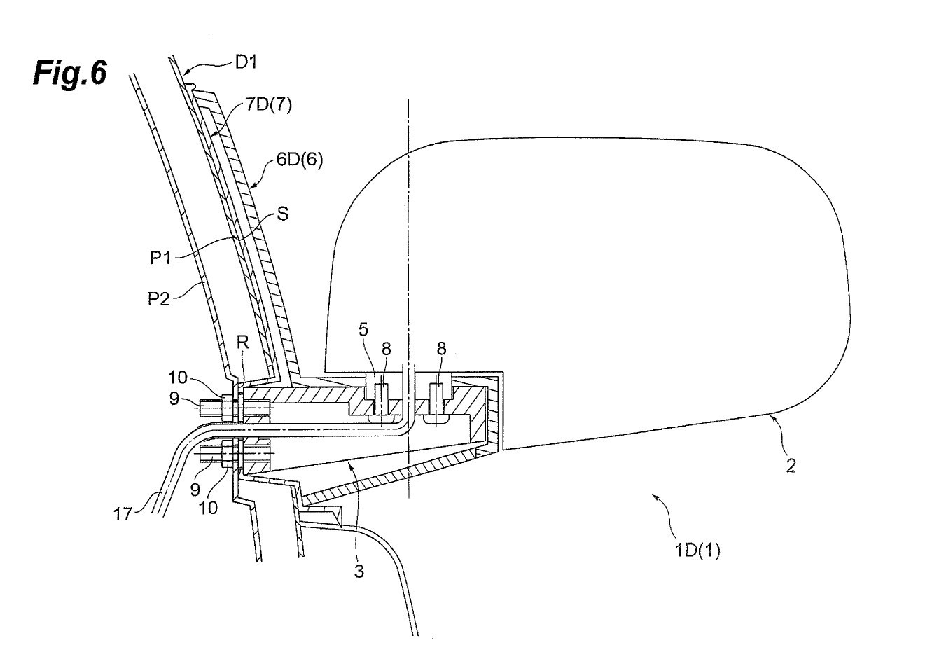

FIG. 6 is a longitudinal cross-sectional view when the door mirror 1 is attached to a different type of vehicle from FIG. 3. The door D1 of the vehicle body shown in FIG. 6 is distinguished from the door D of the vehicle body shown in FIG. 3 in inclination angles of the outer panel P1 and the inner panel P2. In this way, even in the door D1 in which the outer panel P1 and the inner panel P2 stand relatively vertically (an angle of a door surface with respect to the horizontal surface is large), the door mirror attaching part R has the same angle as the type of vehicle shown in FIG. 3. The door mirror 1D attached to the door D1 has the door mirror main body 2, the shared base 3, an exclusive cover 6D and an exclusive gasket 7D.

According to the door mirror 1 (the door mirror 1A to 1D) of the above-mentioned embodiment, the door mirror main body 2 and the shared base 3 shared in different types of vehicles are employed without modifying the door mirror main body and the base for every type of vehicle. Since the door mirror main body 2 is constituted by an assembly of various parts and accounts for most of a manufacturing cost of the door mirror 1, the cost can be largely reduced when the door mirror main body 2 is shared. Then, in order to further reduce the cost, in the door mirror 1, the door mirror base to which the door mirror 1 is attached is also shared. That is, in the door mirror 1, the shared base 3 is fixed to the door mirror attaching part R of the vehicle body, and the shared base 3 supports the shared door mirror main body 2. In this way, since the shared base 3 is used, sharing of the door mirror base with respect to the plurality of types of vehicles becomes possible. Further, the exclusive cover 6 (the exclusive cover 6A, 6B, 6C, or the like) is selected from the group of different types of exclusive covers 20 (see FIG. 2), and the exclusive cover 6 covers the peripheral region S of the door mirror attaching part R. Accordingly, by selecting the exclusive cover 6 depending on the type of vehicle, while sharing the door mirror base, a different design is realized for each type of vehicle. That is, the cover can be easily changed and a design property of any type of vehicle can be maintained while largely reducing the cost.

In addition, by covering the shared base 3 with the base cover part 11a, 12a or 13a of the exclusive cover 6, a different design is realized more easily for each type of vehicle.

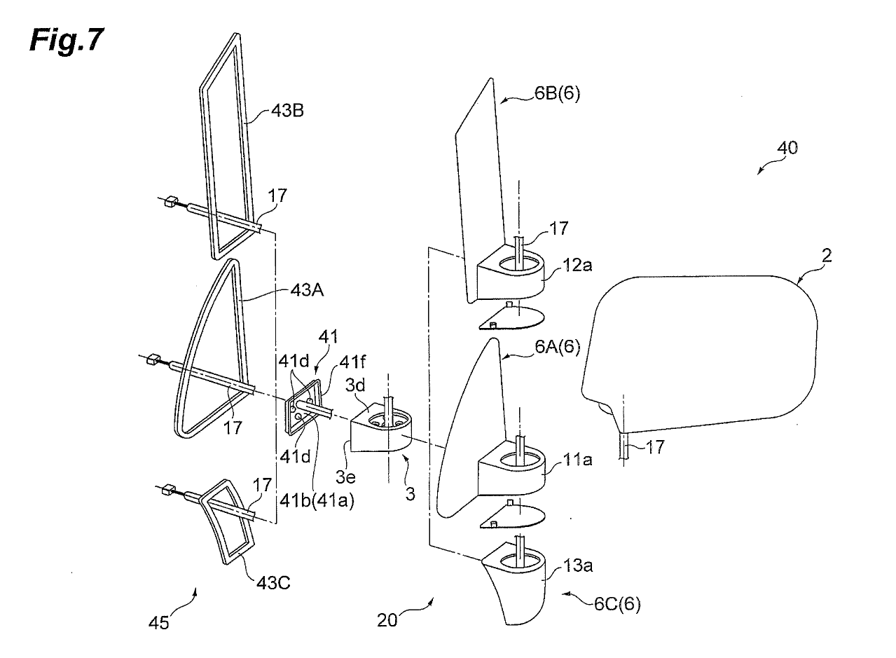

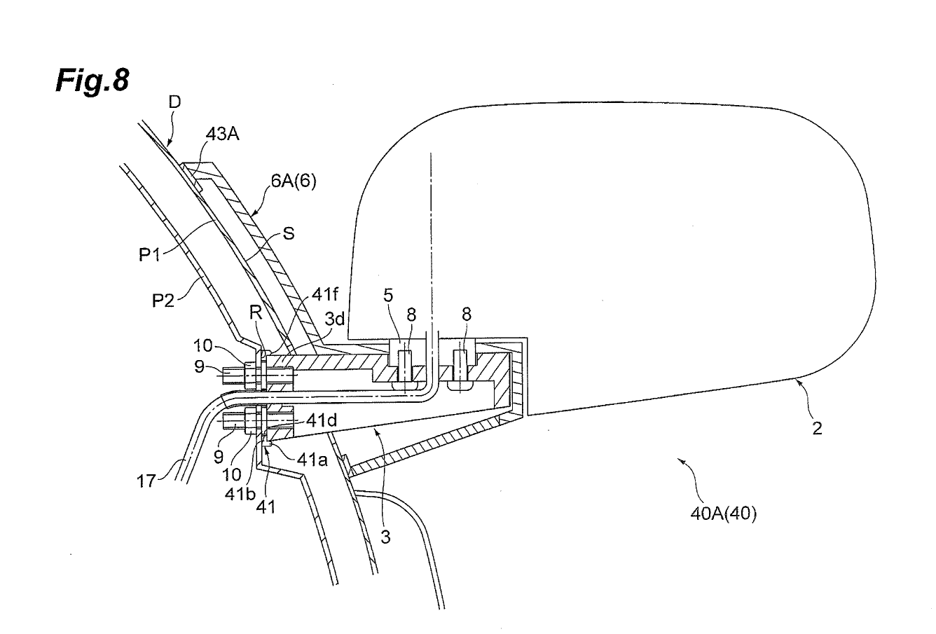

FIG. 7 is an exploded perspective view showing a door mirror 40 according to a second embodiment, and FIG. 8 is a longitudinal cross-sectional view showing a state in which the door mirror 40 of FIG. 7 is attached. The door mirror 40 shown in FIGS. 7 and 8 is distinguished from the door mirror 1 shown in FIGS. 2 to 6 in that a small gasket 41 and annular seal sponges 43A to 43C, which are shared, are used instead of the large exclusive gasket 7. The small gasket 41 has a rectangular shape slightly larger than the attaching surface 3e of the shared base 3. The small gasket 41 has an edge part 41f surrounding the end part of the attaching part 3d. The small gasket 41 has a base fitting part 41a, a base seal part 41b, a bolt insertion hole 41d, and so on, like the exclusive gasket 7. The seal sponges 43A to 43C are sandwiched between peripheries of the exclusive covers 6A to 6C and the outer panel P1. The seal sponges 43A to 43C constitute a group of different types of exclusive seal sponges 45. In FIG. 8, the door mirror 40A including the exclusive cover 6A having the triangular shape is exemplified.

Through the door mirror 40, by selecting the exclusive cover 6 depending on the type of vehicle while attempting to share the door mirror base, different designs are realized for each type of vehicle. Further, by covering the shared base 3 with the base cover part 11a, 12a or 13a of the exclusive cover 6, different designs are realized more easily for each type of vehicle.

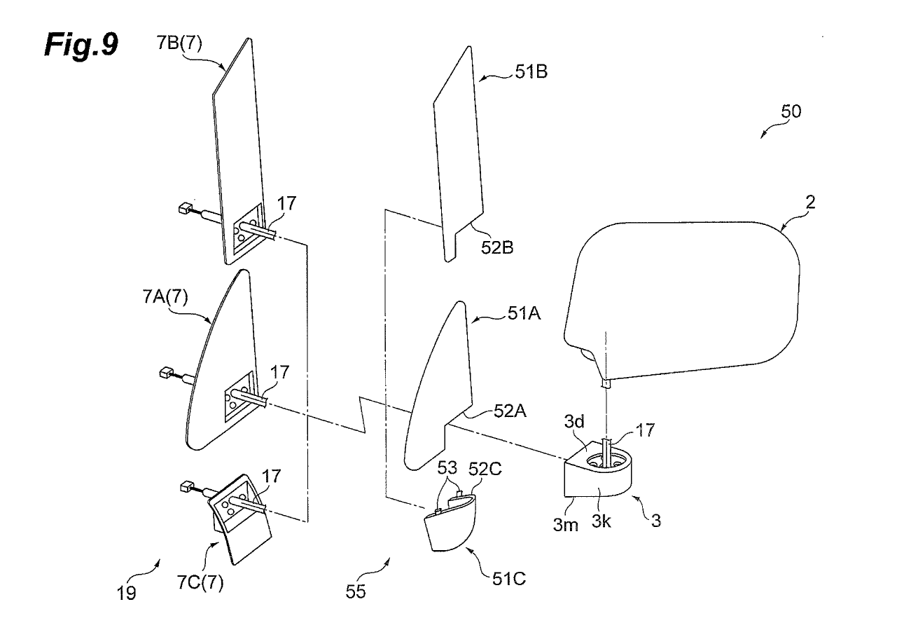

FIG. 9 is an exploded perspective view showing a door mirror 50 according to a third embodiment. The door mirror 50 shown in FIG. 9 is distinguished from the door mirror 1 shown in FIGS. 2 to 6 in that exclusive covers 51A to 51C configured to expose the shared base 3 are used instead of the exclusive cover 6 having the base cover parts 11a, 12a and 13a configured to cover the shared base 3. A notch 52A is formed in the exclusive cover 51A along the outer periphery of the attaching part 3d of the shared base 3. A notch 52B is formed in the exclusive cover 51B along the outer periphery of the attaching part 3d of the shared base 3. An upper end edge 52C is formed in the exclusive cover 51C along a U-shaped lower end edge 3m of the peripheral wall 3k of the shared base 3. Further, a locking piece 53 locked to the lower end edge 3m of the peripheral wall 3k is installed in the upper end edge 52C of the exclusive cover 51C. The exclusive covers 51A, 51B and 51C constitute an exclusive cover group 55.

Through the door mirror 50, by selecting any one of the exclusive covers 51A to 51C depending on the type of vehicle while attempting to share the door mirror base, different designs are realized for each type of vehicle. Further, since the exclusive covers 51A to 51C do not cover the shared base 3, a range covered by the exclusive covers 51A to 51C is reduced to that extent. That is, the exclusive covers 51A to 51C cover only the peripheral region S of the door D. Accordingly, a material cost for manufacturing the exclusive covers 51A to 51C can be reduced while increasing a degree of freedom in design of the exclusive covers 51A to 51C.

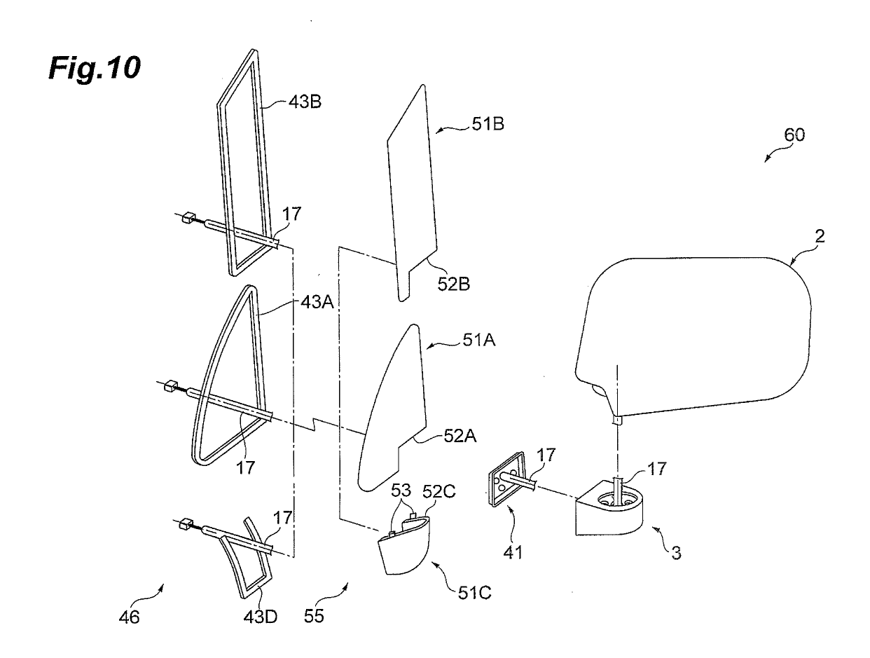

FIG. 10 is an exploded perspective view showing a door mirror 60 according to a fourth embodiment. The door mirror 60 shown in FIG. 10 is distinguished from the door mirror 1 shown in FIGS. 2 to 6 in that the exclusive covers 51A to 51C configured to expose the shared base 3 is used instead of the exclusive cover 6 having the base cover parts 11a, 12a and 13a configured to cover the shared base 3, and in that the small gasket 41 and the seal sponges 43A, 43B and 43D, which are shared, are used instead of the large exclusive gasket 7. That is, in the door mirror 60, a configuration of the exclusive cover of the door mirror 50 configured to expose the shared base 3 and a configuration of the gasket and the seal sponge of the door mirror 40 are combined. The seal sponges 43A, 43B and 43D constitute a group of different types of exclusive seal sponges 46.

Through the door mirror 60, by selecting any one of the exclusive covers 51A to 51C depending on the type of vehicle while attempting to share the door mirror base, different designs are realized for each type of vehicle. Further, since the exclusive covers 51A to 51C do not cover the shared base 3, a range covered by the exclusive covers 51A to 51C is reduced to that extent. That is, the exclusive covers 51A to 51C cover only the peripheral region S of the door D. Accordingly, a material cost for manufacture of the exclusive covers 51A to 51C is reduced while increasing a degree of freedom in design of the exclusive covers 51A to 51C.

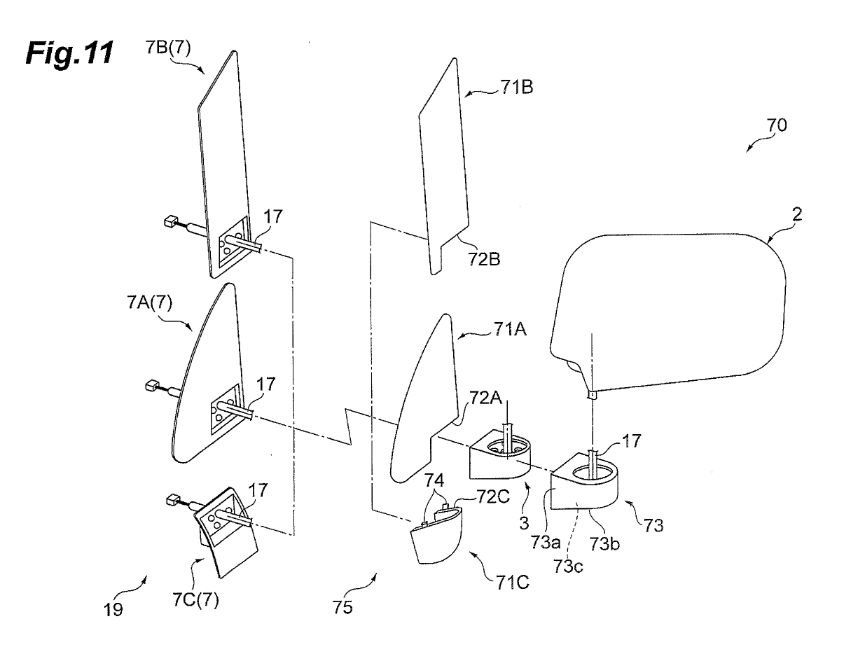

FIG. 11 is an exploded perspective view showing a door mirror 70 according to a fifth embodiment. The door mirror 70 shown in FIG. 11 is distinguished from the door mirror 1 shown in FIGS. 2 to 6 in that a shared base cover 73 to cover the shared base 3 and door covers (exclusive covers) 71A to 71C configured to cover the peripheral region S of the door mirror attaching part R are divided instead of the exclusive cover 6A to 6C. The base cover 73 has the same exterior and interior as the base cover part 11a to 13a of the exclusive cover 6A to 6C. An opening 73c is formed at a bottom surface of the base cover 73. The door covers 71A to 71C have the same shapes as the door cover part 11b to 13b of the exclusive cover 6A to 6C. A notch 72A is formed in the door cover 71A along the outer periphery of the end part 73a of the door mirror attaching part R side of the base cover 73. A notch 72B is formed in the door cover 71B along an outer periphery of an end part 73a of the door mirror attaching part R side of the base cover 73. An upper end edge 72C is formed at the door cover 71C along a lower end edge 73b of the base cover 73. Further, a locking piece 74 entering the opening 73c of the bottom surface of the base cover 73 is installed at the upper end edge 72C of the door cover 71C. The locking piece 74 is locked to the lower end edge 73b of the base cover 73. The door covers 71A, 71B and 71C constitute an exclusive cover group 75.

Through the door mirror 70, by selecting any one of the door covers 71A to 71C depending on the type of vehicle while attempting to share the door mirror base, different designs are realized for each type of vehicle. Further, by covering the shared base 3 with the base cover 73, different designs are realized more easily for each type of vehicle.

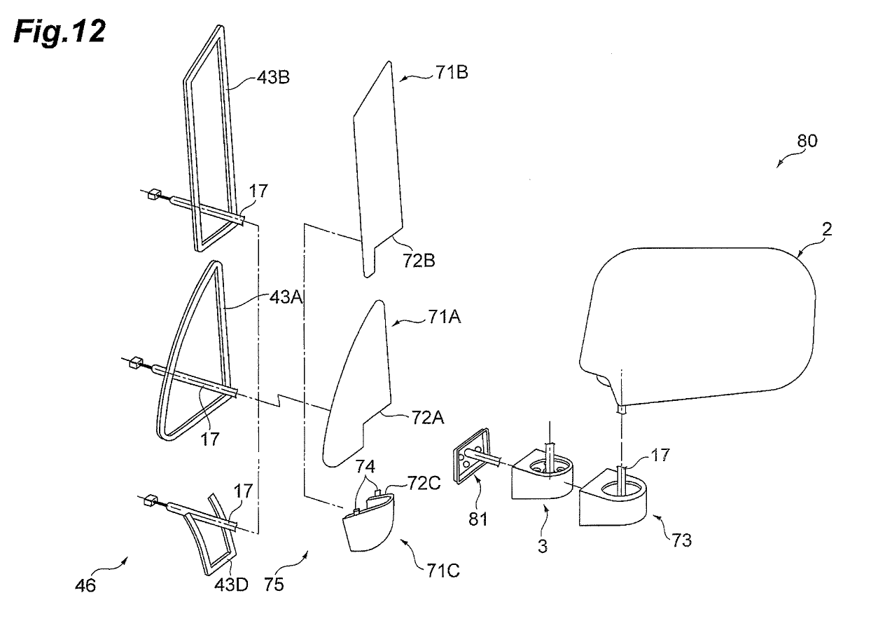

FIG. 12 is an exploded perspective view showing a door mirror 80 according to a sixth embodiment. The door mirror 80 shown in FIG. 12 is distinguished from the door mirror 1 shown in FIGS. 2 to 6 in that the shared base cover 73 to cover the shared base 3 and the door covers (the exclusive covers) 71A to 71C configured to cover the peripheral region S of the door mirror attaching part R are divided instead of the exclusive covers 6A to 6C, and in that a shared small gasket 81 and the seal sponges 43A, 43B and 43D are used instead of the large exclusive gasket 7. That is, in the door mirror 80, a configuration in which the cover of the door mirror 70 is divided into two parts and a configuration of the gasket and the seal sponge of the door mirror 60 are combined.

Through the door mirror 80, by selecting any one of the door covers 71A to 71C depending on the type of vehicle while attempting to share the door mirror base, different designs are realized for each type of vehicle. Further, by covering the shared base 3 with the base cover 73, different designs are realized more easily for each type of vehicle.

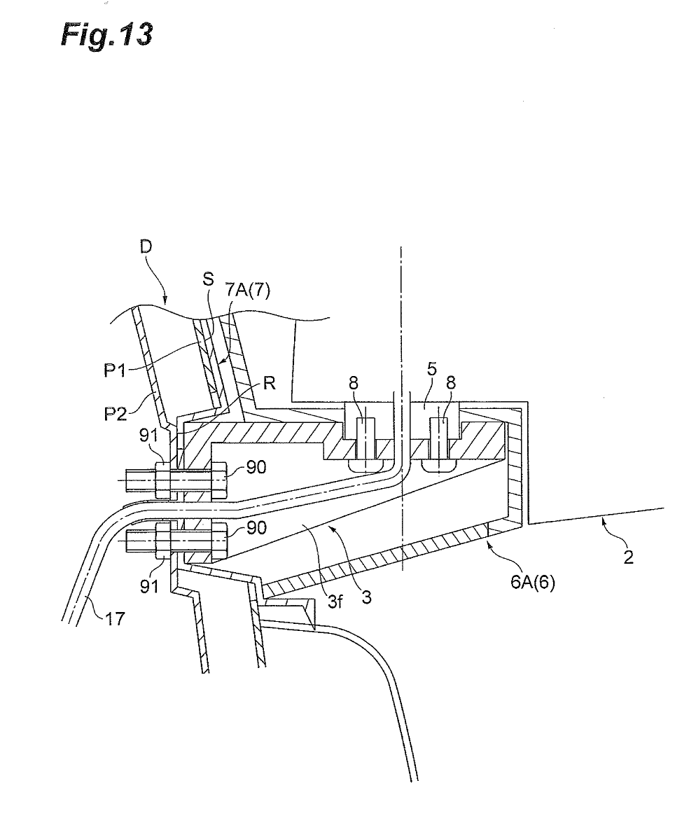

Hereinabove, while the embodiments of the present invention have been described, the present invention is not limited to the above-mentioned embodiments. In the embodiments, while the case in which the stud bolt 9 is installed at the shared base 3 has been described, the shared base 3 may be fixed by another fixing method. For example, as shown in FIG. 13, the shared base 3 may be fixed by inserting a bolt 90 from the shared base 3 side via the opening 3f of the shared base 3 and threadedly engaging a nut 91 from a back surface side of the door mirror attaching part R (the inside of the door D).

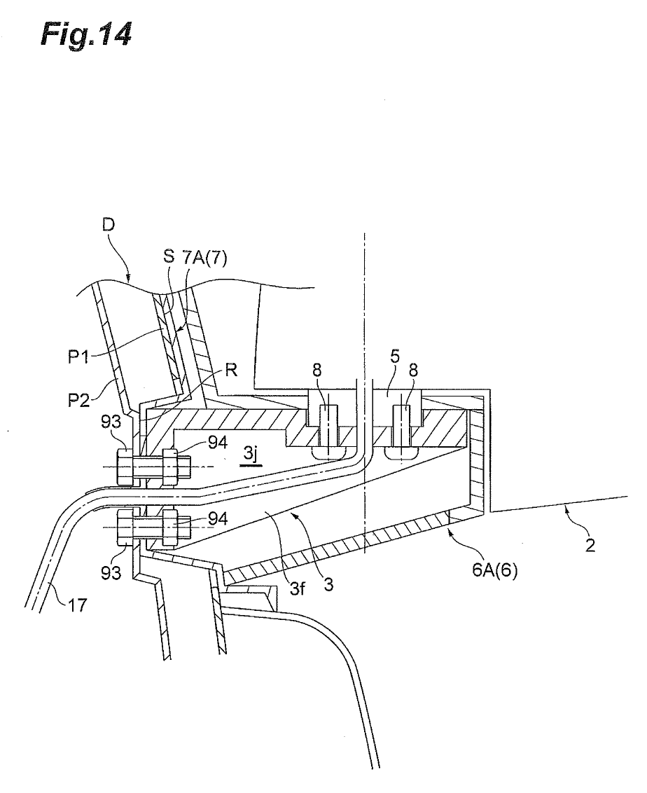

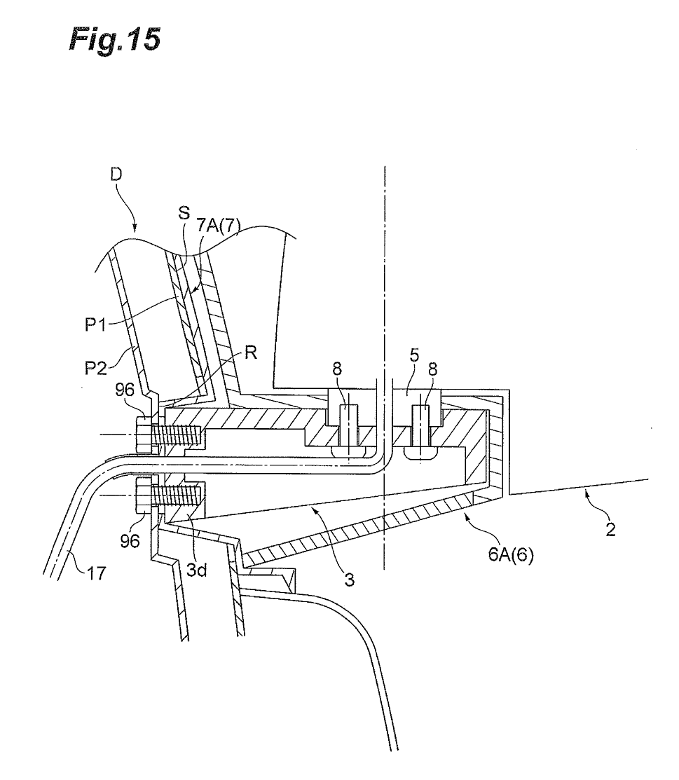

In addition, as shown in FIG. 14, the shared base 3 may be fixed by inserting a bolt 93 from the back surface side of the door mirror attaching part R (the inside of the door D) toward the internal space 3j and threadedly engaging a nut 94 from the shared base 3 via the opening 3f of the shared base 3. In addition, as shown in FIG. 15, the shared base 3 may be fixed by tapping from the back surface side of the door mirror attaching part R (the inside of the door D) to the attaching part 3d by a self-tapping screw 96.

### INDUSTRIAL APPLICABILITY

According to an aspect of the present invention, sharing of the base becomes possible and thus, by also selecting the exclusive cover depending on the type of vehicle, different designs can be realized for each type of vehicle.

### REFERENCE SIGNS LIST

1 . . . door mirror, 2 . . . door mirror main body, 3 . . . shared base, 6, 6A, 6B, 6C, 6D . . . exclusive cover, 20 . . . exclusive cover group, 40, 50 . . . door mirror, 51A, 51B, 51C . . . exclusive cover; 55 . . . exclusive cover group, 60, 70 . . . door mirror, 71A, 71B, 71C . . . door cover (exclusive cover), 75 . . . exclusive cover group, 80 . . . door mirror, R . . . door mirror attaching part, S . . . peripheral region

1. A door mirror having a door mirror main body attached to a door mirror attaching part of a vehicle body, the door mirror comprising:
a shared base fixed to the door mirror attaching part and configured to support the door mirror main body, which is shared; and
an exclusive cover configured to cover a peripheral region of the door mirror attaching part and selected from a group of different types of exclusive covers.

2. The door mirror according to claim 1, wherein the shared base is covered by the exclusive cover.

3. The door mirror according to claim 1, wherein the shared base has a pedestal part to which a lower end of the door mirror main body is fixed,
the exclusive cover has a base cover part configured to cover the shared base, and
an opening configured to expose the pedestal part is formed at the base cover part.

4. The door mirror according to claim 1, wherein the shared base is exposed.

5. The door mirror according to claim 4, wherein a notch is formed in the exclusive cover along an outer periphery of the shared base.

6. The door mirror according to claim 1, wherein the shared base has a flat surface opposite to a lower surface of the door mirror main body, and an attaching surface pressed against the door mirror attaching part,
an angle of the attaching surface with respect to the flat surface is equal to an angle of the door mirror attaching part with respect to a horizontal surface.

7. The door mirror according to claim 1, further comprising an exclusive gasket having a shape corresponding to the exclusive cover.
